(19) United States
(12) Patent Application Publication
(10) Pub. No.: US 2012/0329910 A1
(43) Pub. Date: Dec. 27, 2012

(54) Thermoplastic Resin Composition and Molded Product Using the Same

(75) Inventors: Ywan-Hee LEE, Uiwang-si (KR); Doo-Han HA, Uiwang-si (KR); Jin-Young HUH, Uiwang-si (KR)

(73) Assignee: CHEIL INDUSTRIES INC., Gumi-si (KR)

(21) Appl. No.: 13/334,267

(22) Filed: Dec. 22, 2011

(30) Foreign Application Priority Data
Jun. 23, 2011 (KR) 10-2011-0061088

(51) Int. Cl. C08K 13/04; C08L 67/02; C08L 63/02; C08L 51/06; C08L 63/04

(52) U.S. Cl. 523/436

(57) ABSTRACT

Disclosed is a thermoplastic resin composition that includes: a polyester resin (A); an epoxy-modified glass fiber (C); and a hydrolysis resistant additive (D) comprising an alicyclic epoxy compound, a carbodiimide compound, or a combination thereof.

### CROSS-REFERENCE TO RELATED APPLICATION

This application claims priority to and the benefit of Korean Patent Application No. 10-2011-0061088 filed in the Korean Intellectual Property Office on Jun. 23, 2011, the entire disclosure of which is incorporated herein by reference.

### FIELD OF THE INVENTION

A thermoplastic resin composition and a molded product using the same are disclosed.

### BACKGROUND OF THE INVENTION

Currently commerically available blends of polyester resin/ASA (acrylate-styrene-acrylonitrile) resin, ABS (acrylonitrile-butadiene-styrene) resin/glass fiber, and the like are generally used for large molded products having a complicated structure, foe example automobile exterior materials. However, enriching the blend with an inorganic material can negatively impact formability and overload an extruder, which can increase the amount of defective products. Accordingly, there is a need for products with improved fluidity. However, improving fluidity of a resin composition can also deteriorate the mechanical and thermal characteristics of the resin composition.

### SUMMARY OF THE INVENTION

An exemplary embodiment provides a thermoplastic resin composition that can have good physical properties such as mechanical strength due to excellent hydrolysis resistance.

Another embodiment provides a molded product using the thermoplastic resin composition.

According to an embodiment, provided is a thermoplastic resin composition that includes: a polyester resin (A); an epoxy-modified glass fiber (C); and a hydrolysis resistant additive (D) comprising an alicyclic epoxy compound, a carbodiimide compound, or a combination thereof.

A specimen formed from the thermoplastic resin composition can have a tensile strength measured according to ASTM D638 after exposure to USCAR 3 conditions for 40 cycles of greater than or equal to about 90% as compared to the tensile strength before the cycles, and ⅛″ IZOD impact strength measured according to ASTM D256 after exposure to USCAR 3 conditions for 40 cycles of greater than or equal to about 75% as compared to the impact strength before the cycles, wherein 1 cycle of the USCAR 3 includes heating and humidifying under the conditions of about 90° C. temperature and about 90% relative humidity for one hour; maintaining the conditions for 5 hours; heating to about 125° C. for one hour; and maintaining the temperature of about 125° C. and the relative humidity of about 90% for 5 hours.

The thermoplastic resin composition may further include a vinyl-based graft copolymer (B).

The vinyl-based graft copolymer (B) may be a graft copolymer including a vinyl-based polymer comprising an aromatic vinyl compound, an acrylic-based compound, a vinyl cyanide compound, or a combination thereof grafted into a rubbery polymer comprising a butadiene rubber, an acrylic rubber, an ethylene/propylene rubber, a styrene/butadiene rubber, an acrylonitrile/butadiene rubber, an isoprene rubber, an ethylene-propylene-diene terpolymer (EPDM) rubber, a polyorganosiloxane/polyalkyl(meth)acrylate rubber, or a combination thereof, or a mixture thereof.

The vinyl-based graft copolymer (B) may be a mixture that further includes a vinyl-based copolymer comprising an aromatic vinyl compound, an acrylic-based compound, a vinyl cyanide compound, or a combination thereof.

The thermoplastic resin composition may include: about 100 parts by weight of the polyester resin (A); about 10 to about 100 parts by weight of the vinyl-based graft copolymer (B); and about 70 to about 200 parts by weight of the epoxy-modified glass fiber (C), and further include about 0.01 to about 5 parts by weight of a hydrolysis resistant additive (D) comprising an alicyclic epoxy compound, a carbodiimide compound, or a combination thereof, based on about 100 parts by weight of the polyester resin (A), the vinyl-based graft copolymer (B), and the epoxy-modified glass fiber (C).

Examples of the polyester resin (A) may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin in which one of the foregoing resins is modified to be non-crystalline, and the like, and combinations thereof.

The epoxy-modified glass fiber (C) may be a glass fiber that is surface-treated with at least one epoxy compound. Examples of the epoxy compound may include without limitation bisphenol-type epoxy compounds, novolac epoxy compounds, polyglycidylester compounds, alicyclic epoxy compounds, glycidylether compounds, epoxy group-containing copolymers, and the like, and combinations thereof.

Examples of the alicyclic epoxy compound may include without limitation compounds including a plurality of epoxy cycloalkane backbones linked to each other through an ester bond, compounds including a plurality of epoxy cycloalkane backbones linked to each other through a heteroring, epoxycycloalkanes having an epoxyalkyl group, and the like, and combinations thereof.

Examples of the carbodiimide compound may include without limitation N,N′-di-o-tolylcarbodiimide, N,N′-diphenylcarbodiimide, N,N′-dioctyldecylcarbodiimide, N-tolyl-N′ cyclohexyl carbodiimide, N,N′-di-2,6-diisopropylphenylcarbodiimide, N,N′-di-2,6-di-tertiary-butylphenylcarbodiimide, N-tolyl-N′-phenyl carbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, carbodiimide, p-phenylene-bis-di-o-tolylcarbodiimide, p-phenylene-bisdicyclohexylcarbodiimide, hexamethylene-bisdicyclohexylcarbodiimide, ethylene-bisdiphenylcarbodiimide, a benzene-2,4-diisocyanato-1,3,5-tris(1-methylethyl)homopolymer, a copolymer of 2,4-diisocyanato-1,3,5-tris(1-methylethyl) and 2,6-diisopropyl diisocyanate, and the like, and combinations thereof.

The thermoplastic resin composition may further include an additive comprising an antibacterial agent, a heat stabilizer, an antioxidant, a release agent, a light stabilizer, a compatibilizer, an inorganic material additive, a surfactant, a coupling agent, a plasticizer, an admixture, a stabilizer, a lubricant, an antistatic agent, a flameproofing agent, a weather-resistance agent, a colorant, an ultraviolet (UV) blocking agent, a filler, a nucleating agent, an adhesion aid, an adhesive, and the like, and combinations thereof.

Exemplary embodiments further provide a molded product manufactured using the thermoplastic resin composition.

Hereinafter, further embodiments of the present invention will be described in detail.

The thermoplastic resin composition may maintain excellent mechanical properties due to good hydrolysis resistance.

### BRIEF DESCRIPTION OF THE DRAWING

FIG. 1 shows the conditions of 1 cycle according to USCAR 3.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with at least a substituent comprising halogen (F, Cl, Br, I), a hydroxyl group, a nitro group, a cyano group, an amino group, an azido group, an amidino group, a hydrazine group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or a combination thereof.

When a specific definition is not provided, the term “(meth)acrylate” refers to “acrylate” and “methacrylate”. “(Meth)acrylic acid alkyl ester” refers to both “acrylic acid alkyl ester” and “methacrylic acid alkyl ester”, and “(meth)acrylic acid ester” refers to both “acrylic acid ester” and “methacrylic acid ester”.

The thermoplastic resin composition according to one embodiment of the present invention includes (A) a polyester resin, (B) a vinyl-based graft copolymer, (C) an epoxy-modified glass fiber, and (D) a hydrolysis resistant additive (D) comprising an alicyclic epoxy compound, a carbodiimide compound, or a combination thereof.

By simultaneously mixing the epoxy-modified glass fiber (C) and the hydrolysis resistant additive (D), the thermoplastic resin composition may significantly reduce the decomposition speed of the primary resin by hydrolysis, and thereby the molded product of the thermoplastic resin composition may have ensured long term reliability. The thermoplastic resin composition may be used for molded products having a large size, a complex structure, and/or a thin thickness. In exemplary embodiments, the thermoplastic resin composition may be used as an exterior material for an automobile.

Each component included in the thermoplastic resin composition will hereinafter be described in detail.

(A) Polyester Resin

The polyester resin, which is an aromatic polyester resin, may be a condensation polymerized resin obtained by melt-polymerizing terephthalic acid or terephthalic acid alkyl ester and a glycol component having about 2 to about 10 carbon atoms. As used herein with reference to the terephthalic acid alkyl ester, the alkyl may refer to C1 to C10 alkyl.

Examples of the polyester resin may include without limitation a polyethylene terephthalate resin, a polytrimethylene terephthalate resin, a polybutylene terephthalate resin, a polyhexamethylene terephthalate resin, a polycyclohexane dimethylene terephthalate resin, a polyester resin in which one of the foregoing resins is modified to be a non-crystalline resin, and the like. These may be used singularly or as a combination of two or more.

In the case of a mixture, the polyethylene terephthalate resin may be mixed with the polybutylene terephthalate resin. In this case, about 10 to about 40 wt % of the polyethylene terephthalate resin may be mixed with about 60 to about 90 wt % of the polybutylene terephthalate resin.

In some embodiments, a mixture of polyethylene terephthalate resin and polybutylene terephthalate resin may include polyethylene terephthalate resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of polyethylene terephthalate resin can be in a range from about any of the foregoing amounts to about any other of the foregoing amounts.

In some embodiments, a mixture of polyethylene terephthalate resin and polybutylene terephthalate resin may include polybutylene terephthalate resin in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of polybutylene terephthalate resin can be in a range from about any of the foregoing amounts to about any other of the foregoing amounts.

When the polyethylene terephthalate resin and the polybutylene terephthalate resin are mixed in an amount within the above range, the thermoplastic resin composition may have excellent mechanical strength, heat resistance, and workability.

The polyethylene terephthalate resin may have crystallinity of greater than or equal to about 40%, for example, about 40 to about 60%. When the polyethylene terephthalate resin has a crystallinity within the above range, the thermoplastic resin composition may have excellent mechanical strength, impact resistance, heat resistance, and workability as well as excellent size stability and appearance.

The polyester resin may have a specific gravity of about 1.15 to about 1.4 g/cm³ and a melting point of about 210 to about 280° C. When the polyester resin has a specific gravity and a melting point within the above range, the thermoplastic resin composition may have excellent mechanical properties and formability.

(B) Vinyl-Based Graft Copolymer

The vinyl-based graft copolymer (B) may be a copolymer in which about 5 to about 95 wt % of a rubbery polymer is grafted with about 5 to about 95 wt % of a vinyl-based polymer.

In some embodiments, the vinyl-based graft copolymer (B) may include a rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the rubbery polymer can be in a range from about any of the foregoing amounts to about any other of the foregoing amounts.

In some embodiments, the vinyl-based graft copolymer (B) may include a vinyl-based polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the vinyl-based polymer can be in a range from about any of the foregoing amounts to about any other of the foregoing amounts.

Examples of the rubbery polymer may include without limitation butadiene rubber, acrylic rubber, ethylene/propylene rubber, styrene/butadiene rubber, acrylonitrile/butadiene rubber, isoprene rubber, ethylene-propylene-diene terpolymer (EPDM) rubber, polyorganosiloxane/polyalkyl(meth)acrylate rubber, and the like, which may be used singularly or as a combination of two or more.

The acrylic rubber may include (meth)acrylic acid alkyl ester, (meth)acrylic acid ester, or a polymer thereof. As used herein with reference to the acrylic rubber, the alkyl may refer to C1 to C10 alkyl. Examples of the (meth)acrylic acid alkyl ester may include without limitation methyl(meth)acrylate, ethyl(meth)acrylate, butyl(meth)acrylate, and the like, and combinations thereof. Examples of the (meth)acrylic acid ester may include without limitation (meth)acrylate and the like.

The vinyl-based polymer may include an aromatic vinyl compound, an acrylic-based compound, a vinyl cyanide compound, or a combination thereof.

Examples of the aromatic vinyl compound may include without limitation styrene, o-ethyl styrene, m-ethyl styrene, p-ethyl styrene, α-methyl styrene, and the like, which may be used singularly or as a combination of two or more.

Examples of the acrylic-based compound may include without limitation (meth)acrylic acid alkyl ester, (meth)acrylic acid ester, and the like, which may be used singularly or as a combination of two or more. As used herein with reference to the acrylic-based compound, the alkyl may refer to C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may include without limitation (meth)acrylate, and the like.

Examples of the vinyl cyanide compound may include without limitation acrylonitrile, methacrylonitrile, ethacrylonitrile, and the like, which may be used singularly or as a combination of two or more.

Examples of the vinyl-based graft copolymer may include without limitation a butadiene rubber-containing copolymer in which a polymer of an aromatic vinyl compound and a vinyl cyanide compound is grafted to the butadiene rubber, an acrylic rubber-containing copolymer in which a polymer of an aromatic vinyl compound and a vinyl cyanide compound is grafted to the acrylic rubber, and the like, and combinations thereof.

The butadiene rubber may have an average particle diameter of about 0.05 to about 4 μm. When the average particle diameter is within the above range, it may provide excellent impact resistance and surface characteristics.

A method of preparing the butadiene rubber-containing copolymer is well-known to a person skilled in the art, and for example, it may include emulsion polymerization, suspension polymerization, solution polymerization, or massive polymerization, and particularly, emulsion polymerization or massive polymerization. In an emulsion polymerization or massive polymerization, the butadiene rubber-containing copolymer may be polymerized by adding an aromatic vinyl compound and a polymerization initiator in the presence of butadiene rubber.

The vinyl-based graft copolymer (B) may be used as a mixture further including a vinyl-based copolymer.

The vinyl-based copolymer may include a copolymer in which at least two compounds selected from an aromatic vinyl compound, a vinyl cyanide compound, an acrylic-based compound, and a heterocyclic compound are polymerized. In exemplary embodiments, a copolymer of aromatic vinyl compound and vinyl cyanide compound may be used.

An exemplary copolymer of aromatic vinyl compound and vinyl cyanide compound may be a copolymer including about 50 to about 80 wt % of the aromatic vinyl compound and about 20 to about 50 wt % of the vinyl cyanide compound.

The copolymer of aromatic vinyl compound and vinyl cyanide may include aromatic vinyl compound in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of aromatic vinyl compound can be in a range from about any of the foregoing amounts to about any other of the foregoing amounts.

The copolymer of aromatic vinyl compound and vinyl cyanide may include vinyl cyanide in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of vinyl cyanide can be in a range from about any of the foregoing amounts to about any other of the foregoing amounts.

When the copolymer of aromatic vinyl compound and vinyl cyanide includes aromatic vinyl compound and vinyl cyanide in an amount within the above ratio range, the thermoplastic resin composition may have excellent coloring properties, impact resistance, and weather resistance.

Examples of the aromatic vinyl compound may include without limitation styrene, C1 to C10 alkyl-substituted styrene, halogen-substituted styrene, and the like, and combinations thereof. Examples of the alkyl substituted styrene may include without limitation o-ethyl styrene, m-ethyl styrene, p-ethyl styrene, α-methyl styrene, and the like, and combinations thereof.

Examples of the vinyl cyanide compound may include without limitation be acrylonitrile, methacrylonitrile, ethacrylonitrile, and the like, and combinations thereof.

The acrylic-based compound may include (meth)acrylic acid alkyl ester, (meth)acrylic acid ester, or a combination thereof. As used herein with reference to the acrylic-based compound, the alkyl may refer to C1 to C10 alkyl. Examples of the (meth)acrylic acid alkyl ester may include without limitation methyl(meth)acrylate, ethyl(meth)acrylate, butyl(meth)acrylate, and the like, and combinations thereof. Examples of the (meth)acrylic acid ester may include without limitation (meth)acrylate and the like.

Examples of the heterocyclic compound may include without limitation maleic anhydride, C1-C10 alkyl or phenyl-N-substituted maleimide, and the like, and combinations thereof.

Examples of the vinyl-based copolymer may include without limitation a copolymer of styrene, acrylonitrile, and optionally methylmethacrylate; a copolymer of α-methylstyrene, acrylonitrile and optionally methylmethacrylate; a copolymer of styrene, α-methylstyrene, acrylonitrile, and optionally methylmethacrylate; and the like; and combinations thereof.

The vinyl-based copolymer may be prepared by emulsion polymerization, suspension polymerization, solution polymerization, or massive polymerization, and it may have a weight average molecular weight of about 15,000 to about 400,000 g/mol.

The vinyl-based graft copolymer (B) may include the vinyl-based copolymer in an amount of about 50 to about 400 parts by weight, for example, about 100 to about 300 parts by weight, based on about 100 parts by weight of the vinyl-based graft copolymer (B). When the vinyl-based graft copolymer (B) includes the vinyl-based copolymer in an amount within the above range, the thermoplastic resin composition may have excellent coloring properties, impact resistance, and weather resistance.

The thermoplastic resin composition may include the vinyl-based graft copolymer (B) or the vinyl-based graft copolymer (B) and the vinyl-based copolymer when the vinyl-based copolymer is present (that is, the amount of the vinyl-based graft copolymer (B) includes the amount of the vinyl-based copolymer when the vinyl-based copolymer is present) in an amount of about 10 to about 100 parts by weight, for example, from about 30 to about 80 parts by weight, based on about 100 parts by weight of the polyester resin (A).

In some embodiments, the thermoplastic resin composition may include the vinyl-based graft copolymer (B) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of the vinyl-based graft copolymer (B) can be in a range from about any of the foregoing amounts to about any other of the foregoing amounts.

When thermoplastic resin composition includes the vinyl-based graft copolymer in an amount within the above range, the thermoplastic resin composition can have an enhanced balance of physical properties such as impact characteristics and fluidity and also may have excellent heat resistance.

(C) Epoxy-Modified Glass Fiber

The epoxy-modified glass fiber (C) is prepared by modifying glass fiber with an epoxy compound. The epoxy-modified glass fiber (C) may be obtained by, for example, surface-treating glass fiber with an epoxy compound or providing glass fiber with a coating layer including an epoxy compound. By modifying the glass fiber with the epoxy compound, reaction with the resin in the thermoplastic resin composition may be prevented, and the degree of impregnation may be improved. The glass fiber may be modified with epoxy during the manufacture of the glass fiber or after the glass fiber is manufactured.

The glass fiber may be any one generally commercially available in the market. The glass fiber may have a diameter of about 8 to about 20 μm and a length of about 1.5 to about 8 mm. When the glass fiber has a diameter within the above range, the impact resistance of thermoplastic resin composition may be effectively enforced; and when the glass fiber has a length within the above range, it may be easily introduced into the extruder, and the impact resistance of thermoplastic resin composition may be remarkably enforced.

The glass fiber may include fiber obtained from carbon fiber, basaltic fiber, a biomass, or a mixture thereof. The term biomass refers to an organism using an energy source of a plant or a microorganism, or the like.

The cross-sectional shape of the glass fiber is not limited. For example, the glass fiber may have a cross-section of a circle, an oval, a rectangular, or a two circle-linked dumbbell shape.

The cross-section of glass fiber may have an aspect ratio of less than about 1.5, for example, of a circle with an aspect ratio of about 1. The aspect ratio is defined as a ratio of the longest diameter of glass fiber to the shortest diameter thereof. When the glass fiber has a cross-section within the above aspect ratio range, the product cost may be reduced, and the size, stability and appearance may be improved by using glass fiber with a circular cross-section.

The glass fiber may be treated by a treating agent such as a lubricant, a coupling agent, a surfactant, and the like while fabricating the glass fiber or after the glass fiber is fabricated. The lubricant may be used to provide good strands having a constant diameter and thickness while fabricating the glass fiber, and the coupling agent can be used to provide good adhesion between the glass fiber and a resin. Appropriate selection of the various glass fiber treating agents based upon the kinds of resin and glass fiber used may provide good physical properties to the glass fiber enforced material.

The glass fiber treated with a glass fiber treating agent may be modified with epoxy, or an epoxy-modified glass fiber may be further treated with a glass fiber treating agent. The glass fiber may also be simultaneously treated with an epoxy compound and a glass fiber treating agent.

The epoxy compound for modifying the glass fiber may be a multi-functional epoxy compound containing at least one epoxy group. Examples of the epoxy compound may include without limitation bisphenol-type epoxy compounds, novolac-type epoxy compounds, polyglycidylester compounds, alicyclic epoxy compounds, glycidylether compounds, epoxy group-containing copolymers, and the like, and combinations thereof. Exemplary epoxy compounds for modifying glass fiber are known in the art, and such compounds, as well as glass fiber already coated with such compounds, are commercially available.

The epoxy-modified glass fiber (C) may include the epoxy compound in an amount of about 0.01 to about 10 parts by weight based on about 100 parts by weight of the glass fiber. In some embodiments, the epoxy-modified glass fiber (C) may include the epoxy compound in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 parts by weight.

Further, according to some embodiments of the present invention, the amount of the epoxy compound can be in a range from about any of the foregoing amounts to about any other of the foregoing amounts.

The thermoplastic resin composition may include the epoxy-modified glass fiber (C) in an amount of about 70 to about 200 parts by weight, for example, at about 80 to about 150 parts by weight, based on about 100 parts by weight of the polyester resin (A). In some embodiments, the thermoplastic resin composition may include the epoxy-modified glass fiber (C) in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200 parts by weight. Further, according to some embodiments of the present invention, the amount of the epoxy-modified glass fiber (C) can be in a range from about any of the foregoing amounts to about any other of the foregoing amounts.

When the thermoplastic resincomposition includes the glass fiber in an amount within the above range, the thermoplastic resin composition may have excellent heat resistance and fluidity to provide excellent formability. When the glass fiber is modified with epoxy, the rate of hydrolysis of the resin in the presence of heat and moisture can be reduced to further improve the hydrolysis resistance characteristics thereof.

(D) Hydrolysis Resistant Additive

Examples of the hydrolysis resistant additive (D) include without limitation alicyclic epoxy compounds, carbodiimide compounds, and the like, and combinations thereof.

The alicyclic epoxy compound may include a compound having an epoxycycloalkane backbone such as 1,2-epoxy_{C5-8}cycloalkane (for example, 1,2-epoxycyclohexane). Examples of such an alicyclic epoxy compound may include without limitation compounds including a plurality of epoxy cycloalkane backbones linked to each other through ester bonds, compounds including a plurality of epoxy cycloalkane backbones linked to each other through heterorings, epoxycycloalkanes having an epoxyalkyl group, and the like, and combinations thereof.

Examples of the compound including a plurality of epoxy cycloalkane backbones linked to each other through ester bonds may include without limitation esters of alcohols having an epoxy cycloalkane backbone (such as 3,4-epoxycyclohexylmethyl-3′,4′-epoxycyclohexanecarboxylate) and lactone adducts thereof (e.g., a lactone such as ε-caprolactone or a lactone polymer (e.g., dimer to tetramer, etc.) and a carboxylic acid having an epoxycyclohexane backbone; diesters of dicarboxylic acid (such as an alicyclic diepoxyadipate) or a lactone adduct thereof (e.g., a lactone such as ε-caprolactone or a lactone polymer (e.g., dimer to tetramer, etc.)) and the above-mentioned alcohol having an epoxycycloalkane backbone; and the like; and combinations thereof. Examples of the alcohol having an epoxycycloalkane backbone may include without limitation epoxycycloalkanols such as 1,2-epoxy-4-hydroxycyclohexane; epoxycycloalkylC₁₋₄alkanols such as 1,2-epoxy-4-hydroxymethylcyclohexane; and the like, and combinations thereof. Examples of the carboxylic acids having an epoxy cycloalkane backbone may include without limitation epoxycycloalkane carboxyl acids such as 1,2-epoxy-4-carboxylcyclohexane; and epoxycycloalkylC₁₋₄alkane-carboxylic acids such as 1,2-epoxy-4-carboxylmethylcyclohexane; and the like, and combinations thereof. Examples of the dicarboxylic acids may include without limitation aliphatic dicarboxylic acids such as adipic acid, aromatic dicarboxylic acids such as terephthalic acid, alicyclic dicarboxylic acids such as hexahydroterephthalic acid, and the like, and combinations thereof.

Examples of the compound including a plurality of epoxy cycloalkane backbones linked to each other through a heteroring may include without limitation compounds in which two epoxy cycloakanes are bonded through a cyclic acetal, such as an alicyclic diepoxyacetal.

Examples of the epoxy cycloalkane having an epoxy alkyl group may include without limitation epoxyC₂₋₄alkyl-epoxyC₅₋₈cycloalkanes such as vinyl cyclohexene dioxide.

In addition, the alicyclic epoxy compounds may be prepared by using a compound having an epoxy group (for example, an alcohol and/or carboxylic acid, etc.) as a raw material in a reaction such as esterification, acetalization, and the like, or may be obtained by subjecting a raw material having no epoxy group to a reaction such as esterification, acetalization, and the like and then epoxidizing the resulting product. For example, an ester of an alcohol having an epoxycycloalkane backbone (such as 3,4-epoxycyclohexylmethyl-3′,4′-epoxycyclohexanecarboxylate or the like) or a lactone adduct thereof (for example, a lactone such as ε-caprolactone or a lactone polymer) and a carboxylic acid having an epoxycycloalkane backbone may be prepared by, for example, epoxydizing a carbon-carbon unsaturated bond in an ester of a cycloalkenecarboxylic acid (for example, tetrahydrophthalic acid anhydride, etc.) and a cycloalkenylalkanol (for example tetrahydrobenzyl alcohol, etc.) or a lactone adduct thereof. For example, such epoxy compounds are commercially available under the tradenames Epolead GT300, Epolead GT400, Celloxide 2081 (a monomer adduct), Celloxide 2083 (a trimer adduct), and Celloxide 2085 (a pentamer adduct) from Daicel Chemical Industries.

Examples of the carbodiimide compound may include without limitation N,N′-di-o-tolylcarbodiimide, N,N′-dipentylcarbodiimide, N,N′-dioctyldecylcarbodiimide, N,N′-di-2,6-dipentylphenylcarbodiimide, N-tolyl-N′ cyclohexyl carbodiimide, N,N′-di-2,6-diisopropylphenylcarbodiimide, N,N′-di-2,6-di-tertiary-butylphenylcarbodiimide, N-tolyl-N′-phenyl carbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′ di-p-tolylcarbodiimide, p-phenylene-bis-di-o-tolylcarbodiimide, p-phenylene-bisdicyclohexylcarbodiimide, hexamethylene-bisdicyclohexylcarbodiimide, ethylene-bisdiphenylcarbodiimide, a benzene-2,4-diisocyanato-1,3,5-tris(1-methylethyl)homopolymer, a copolymer of 2,4-diisocyanato-1,3,5-tris(1-methylethyl) and 2,6-diisopropyl diisocyanate, a copolymer of 2,4-diisocyanato-1,3,5-tris(1-methylethyl) and 2,6-diisopropyl diisocyanate, and the like, and combinations thereof. Exemplary materials may be commercially available under the tradenames STABAXOL 1, STABAXOL P, STABAXOL P-100, STABAXOL KE7646, (Rhein-Chemie, Rheinau GmbH, Germany, and Bayer).

The thermoplastic resin composition may include the hydrolysis resistant additive (D) in an amount of about 0.01 to about 5 parts by weight, for example, about 0.1 to about 2 parts by weight, based on about 100 parts by weight of the polyester resin (A), the vinyl-based graft copolymer (B), and the epoxy-modified glass fiber (C). In some embodiments, the thermoplastic resin composition may include the hydrolysis resistant additive (D) in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, or 5 parts by weight. Further, according to some embodiments of the present invention, the amount of the hydrolysis resistant additive can be in a range from about any of the foregoing amounts to about any other of the foregoing amounts.

When the thermoplastic resin composition includes the hydrolysis resistant additive in an amount within the above range, the thermoplastic resin composition may have sufficient mechanical strength under conditions of high temperature/high humidity, so it is not required to add the hydrolysis resistant additive in a high amount.

(E) Other Additive(s)

The thermoplastic resin composition may further include one or more additives. Examples of the additive include without limitation antibacterial agents, heat stabilizers, antioxidants, release agents, light stabilizers, compatibilizers, inorganic material additives, surfactants, coupling agents, plasticizers, admixtures, stabilizers, lubricants, antistatic agents, flameproofing agents, weather-resistance agents, colorants, ultraviolet (UV) blocking agents, fillers, nucleating agents, adhesion aids, adhesives, and the like, and combinations thereof.

Examples of the release agent include without limitation fluorine-containing polymers, silicone oils, metal stearate salts, metal montanate salts, montanic acid ester waxes, polyethylene waxes, and the like, and combinations thereof. Examples of the colorant may include without limitation dyes, pigments, and the like, and combinations thereof. Examples of the ultraviolet (UV) blocking agent may include without limitation titanium oxide (TiO₂), carbon black, and the like, and combinations thereof. Examples of the filler may include without limitation glass fiber, carbon fiber, silica, mica, alumina, clay, calcium carbonate, calcium sulfate, glass beads, and the like, and combinations thereof. Examples of the nucleating agent may include without limitation talc, clay, and the like, and combinations thereof.

The additive may be added in an appropriate amount as long as it does not deteriorate the physical properties of the thermoplastic resin composition, for example less than or equal to about 40 parts by weight, and as another example, about 0.1 to about 30 parts by weight, based on about 100 parts by weight of the polyester resin (A), the vinyl-based graft copolymer (B), and the glass fiber (C).

The thermoplastic resin composition according to one embodiment of the present invention may be prepared using any well-known method. For example, each component according to one embodiment of the present invention can be simultaneously mixed with other optional additive(s), and the mixture can be melt-extruded and prepared into pellets.

According to another embodiment of the present invention, the thermoplastic resin composition is molded to provide a molded product. The molded product may have a large size, a complicated structure, and/or a thin thickness and may have good mechanical properties, thermal characteristics, and/or formability, and for example, it may be used for an automobile exterior material.

The following examples illustrate this disclosure in more detail. However, it is understood that this disclosure is not limited by these examples.

### EXAMPLES

A thermoplastic resin composition according to one embodiment includes each component as follows.

(A) Polyester Resin

As a polybutylene terephthalate (PBT) resin, Shinite K001 manufactured by Shingkong is used.

Polyethylene terephthalate (PET) resin, SKYPET 1100 manufactured by SK Chemical, is used.

(B) Vinyl-Based Graft Copolymer

(b1) ASA Graft Resin

ASA resin in which 50 wt % of a polymer of styrene and acrylonitrile is grafted to 50 wt % of acrylate rubber having an average particle diameter of 1700 Å is used.

(b2) Styrene-Acylonitrile (SAN) Resin

0.17 parts by weight of azobisisobutyronitrile, 0.4 parts by weight of t-dodecyl mercaptan chain-transfer agent, and 0.5 parts by weight of tricalcium phosphate are added to a mixture of 71.5 parts by weight of styrene, 28.5 parts by weight of acrylonitrile, and 120 parts by weight of deionized water and suspension-polymerized at 75° C. for 5 hours to provide a SAN copolymer resin. The copolymer is washed, dehydrated, and dried to provide a SAN copolymer resin powder.

The (b1) ASA graft resin and the (b2) SAN resin are mixed in a weight ratio of 1:2.

(C) Epoxy-Modified Glass Fiber

NEG T-125H commercially available from NEG is used.

(C-1) Glass Fiber

Nitto ECS 0.3T-187H commercially available from Nitto is used.

(D) Hydrolysis-Resist Additive

(D-1) Additive-1

An epoxy compound (manufactured by Daicel Chemical Industries) represented by the following Chemical Formula 1 is used.

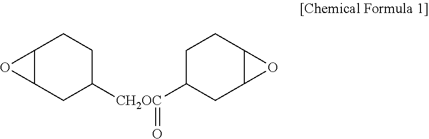

(D-2) Additive-2

A carbodiimide compound (manufactured by RASCHIG GmBH) represented by the following Chemical Formula 2 is used.

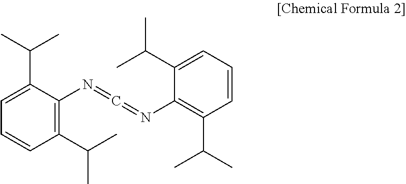

### Examples 1 to 6 and Comparative Examples 1 to 6

Each thermoplastic resin composition according to Examples 1 to 6 and Comparative Examples 1 to 6 is prepared using the components stated above according to the composition shown in the following Table 1.

Each component of the compositions shown in the following Table 1 is mixed and extruded by a twin-screw extruder having L/D=29 and a diameter of 45 mm at 250° C. to provide pellets.

### Experimental Example 1

### Measurement of Mechanical Properties

The pellets obtained from Examples 1 to 6 and Comparative Examples 1 to 5 are dried at 110° C. for more than or equal to 3 hours and injected at a molding temperature of 200 to 300° C. and a mold temperature of 60 to 100° C. into a 10 oz injection mold to provide a specimen for evaluating physical properties. The physical properties of the prepared specimens are measured by the following methods, and the results are shown in the following Table 1.

(1) Tensile strength (TS): measured according to ASTM D638 (measurement condition: tensile speed of 5 mm/min).

(2) IZOD Impact strength: measured according to ASTM D256 (specimen thickness: ⅛″).

The temperature and humidity are changed according to the following conditions (USCAR 3 conditions) and set as 1 cycle. The initial specimen and the specimen after 40 cycles are measured for tensile strength and IZOD impact strength, and the results are shown in the following Table 1.

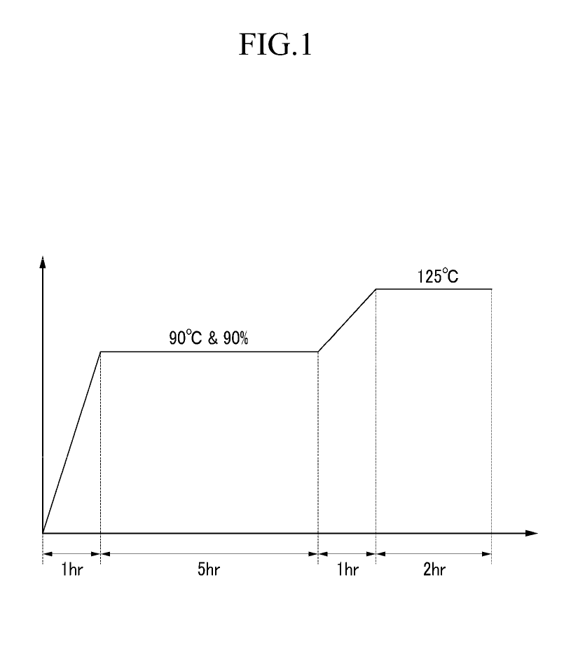

The 1 cycle conditions according to USCAR 3 are: heating and humidifying the specimen under the conditions of a temperature of about 90° C. and about 90% relative humidity for one hour, maintaining these conditions for 5 hours, heating the specimen to a temperature of about 125° C. while maintaining a relative humidity of about 90% for one hour, and maintaining the temperature of about 125° C. and the humidity of about 90% for 5 hours. FIG. 1 shows the 1 cycle temperature and relative humidity conditions.

TABLE 1

| | | | | | | | | | Izod |
|---|---|---|---|---|---|---|---|---|---|
| | | | | | | | | Tensile | impact |
| | | | Vinyl- | | | Alicyclic | | strength | strength |
| | | | based | | | epoxy | Carbodiimide | after 40 | after 40 |
| | Polyester | | graft | Epoxy- | | compound | compound | cycles | cycles |
| | resin | | copolymer | modified | Glass | (D-1) | (D-2) | (% relative | (% relative |
| | (A) | | (B) | glass | fiber | (parts by | (parts by | to initial | to initial |
| | PBT | PET | ASA | fiber (C) | (C-1) | weight) | weight) | one) | one) |
| Example 1 | 40 | 0 | 20 | 40 | — | 0.5 | — | 94 | 87 |
| Example 2 | 40 | 0 | 20 | 40 | — | 1 | — | 96 | 89 |
| Example 3 | 0 | 40 | 20 | 40 | — | 1 | — | 95 | 88 |
| Example 4 | 40 | 0 | 20 | 40 | — | — | 0.5 | 92 | 86 |
| Example 5 | 40 | 0 | 20 | 40 | — | — | 1 | 94 | 87 |
| Example 6 | 0 | 40 | 20 | 40 | — | — | 1 | 94 | 86 |
| Comparative | 40 | 0 | 20 | — | 40 | — | — | 83 | 65 |
| Example 1 | | | | | | | | | |
| Comparative | 40 | 0 | 20 | — | 40 | 0.5 | — | 86 | 69 |
| Example 2 | | | | | | | | | |
| Comparative | 40 | 0 | 20 | — | 40 | 1 | — | 88 | 73 |
| Example 3 | | | | | | | | | |
| Comparative | 40 | 0 | 20 | — | 40 | — | 0.5 | 84 | 67 |
| Example 4 | | | | | | | | | |
| Comparative | 40 | 0 | 20 | — | 40 | — | 1 | 86 | 70 |
| Example 5 | | | | | | | | | |
| Comparative | 60 | 0 | 0 | 40 | — | 0.5 | — | 84 | 67 |
| Example 6 | | | | | | | | | |

Examples 1 to 6 including the epoxy-modified glass fiber and the additive of an alicyclic epoxy compound or a carbodiimide compound exhibit better tensile strength and impact strength, and thus excellent hydrolysis resistance, after exposure to conditions of high heat and humidity for 40 cycles, compared to Comparative Examples 1 to 6 including general glass fibers and the additives. The results confirm that Examples 1 to 6 satisfy the hydrolysis resistance characteristics required for an exterior material such as an automobile product under the hood (UTH), so compositions according to the invention may be used to manufacture articles in this application field.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition, comprising:
a polyester resin (A);
a vinyl-based graft copolymer (B);
an epoxy-modified glass fiber (C); and
an alicyclic epoxy compound, a carbodiimide compound, or a combination thereof (D).

2. The thermoplastic resin composition of claim 1, wherein the vinyl-based graft copolymer (B) is a graft copolymer including a vinyl-based polymer comprising an aromatic vinyl compound, an acrylic-based compound, a vinyl cyanide compound, or a combination thereof that is grafted into
a rubbery polymer comprising a butadiene rubber, an acrylic rubber, an ethylene/propylene rubber, a styrene/butadiene rubber, an acrylonitrile/butadiene rubber, an isoprene rubber, an ethylene-propylene-diene terpolymer (EPDM) rubber, a polyorganosiloxane/polyalkyl(meth)acrylate rubber, or a combination thereof, or a mixture thereof.

3. The thermoplastic resin composition of claim 2, wherein the vinyl-based graft copolymer (B) is a mixture that further includes a vinyl-based copolymer comprising an aromatic vinyl compound, an acrylic-based compound, a vinyl cyanide compound, or a combination thereof.

4. The thermoplastic resin composition of claim 1, which comprises:
about 100 parts by weight of the polyester resin (A);
about 10 to about 100 parts by weight of the vinyl-based graft copolymer (B); and
about 70 to about 200 parts by weight of the epoxy-modified glass fiber (C), and
further comprising about 0.01 to about 5 parts by weight of a hydrolysis resistant additive (D) comprising an alicyclic epoxy compound, a carbodiimide compound, or a combination thereof, based on about 100 parts by weight of the polyester resin (A), the vinyl-based graft copolymer (B), and the epoxy-modified glass fiber (C).

5. The thermoplastic resin composition of claim 1, wherein the polyester resin (A) comprises a polyethylene terephthalate resin, a polytrimethylene terephthalate resin, a polybutylene terephthalate resin, a polyhexamethylene terephthalate resin, a polycyclohexane dimethylene terephthalate resin, a polyester resin in which one of the foregoing resins is modified to be a non-crystalline, or a combination thereof.

6. The thermoplastic resin composition of claim 1, wherein the epoxy-modified glass fiber (C) is a glass fiber that is surface-treated with at least one epoxy compound comprising a bisphenol-type epoxy compound, a novolac epoxy compound, a polyglycidylester compound, an alicyclic epoxy compound, a glycidylether compound, or an epoxy group-containing copolymer.

7. The thermoplastic resin composition of claim 1, wherein the alicyclic epoxy compound comprises a compound including a plurality of epoxy cycloalkane backbones linked to each other through an ester bond, a compound including a plurality of epoxy cycloalkane backbones linked to each other through a heteroring, an epoxycycloalkane having an epoxyalkyl group, or a combination thereof.

8. The thermoplastic resin composition of claim 1, wherein the carbodiimide compound comprises N,N′-di-o-tolylcarbodiimide, N,N′-diphenylcarbodiimide, N,N′-dioctyldecylcarbodiimide, N-tolyl-N′ cyclohexyl carbodiimide, N,N′-di-2,6-diisopropylphenylcarbodiimide, N,N′-di-2,6-di-tertiary-butylphenylcarbodiimide, N-tolyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, carbodiimide, p-phenylene-bis-di-o-tolylcarbodiimide, p-phenylene-bisdicyclohexylcarbodiimide, hexamethylene-bisdicyclohexylcarbodiimide, ethylene-bisdiphenylcarbodiimide, a benzene-2,4-diisocyanato-1,3,5-tris(1-methylethyl)homopolymer, a copolymer of 2,4-diisocyanato-1,3,5-tris(1-methylethyl) and 2,6-diisopropyl diisocyanate, or a combination thereof.

9. The thermoplastic resin composition of claim 1, wherein the thermoplastic resin composition further comprises an additive comprising an antibacterial agent, a heat stabilizer, an antioxidant, a release agent, a light stabilizer, a compatibilizer, an inorganic material additive, a surfactant, a coupling agent, a plasticizer, an admixture, a stabilizer, a lubricant, an antistatic agent, a flameproofing agent, a weather-resistance agent, a colorant, an ultraviolet (UV) blocking agent, a filler, a nucleating agent, an adhesion aid, an adhesive, or a combination thereof.

10. A molded product manufactured using the thermoplastic resin composition of claim 1.

11. A thermoplastic resin composition, wherein a molded product manufactured using the thermoplastic resin composition of claim 1 has:
tensile strength measured according to ASTM D638 after exposure to USCAR 3 conditions for 40 cycles of greater than or equal to about 90% as compared to the tensile strength before the cycles, and
⅛″ IZOD impact strength measured according to ASTM D256 after exposure to USCAR 3 conditions for 40 cycles of greater than or equal to about 75% as compared to the impact strength before the cycles,
wherein 1 cycle of the USCAR 3 conditions includes: heating and humidifying at about 90° C. and about 90% relative humidity for one hour; maintaining the conditions for 5 hours; heating to about 125° C. while maintaining the relative humidity of about 90% for one hour; and maintaining the temperature of about 125° C. and the relative humidity of about 90% for 5 hours.

12. The molded product of claim 10, wherein the molded product has tensile strength greater measured according to ASTM D638 after exposure to USCAR 3 conditions for 40 cycles of greater than or equal to about 90% as compared to the tensile strength before the cycles, and ⅛″ IZOD impact strength measured according to ASTM D256 after exposure to USCAR 3 conditions for 40 cycles of greater than or equal to about 75% as compared to the impact strength before the 40 cycles,
wherein 1 cycle of the USCAR 3 conditions includes: heating and humidifying at about 90° C. and about 90% relative humidity for one hour; maintaining the conditions for 5 hours; heating to about 125° C. while maintaining the relative humidity of about 90% for one hour; and maintaining the temperature of about 125° C. and the relative humidity of about 90% for 5 hours.
